(19) United States
(12) Patent Application Publication
(10) Pub. No.: US 2010/0002467 A1
(43) Pub. Date: Jan. 7, 2010

(54) Light Guide Plate and Backlight Module Using the Light Guide Plate

(75) Inventor: Hai-En Tsai, Hsin-Chu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORPORATION, Hsin-Chu (TW)

(21) Appl. No.: 12/485,212

(22) Filed: Jun. 16, 2009

(30) Foreign Application Priority Data
Jul. 2, 2008 (TW) 97124981

(51) Int. Cl. F21V 8/00

(52) U.S. Cl. 362/621; 362/330

(57) ABSTRACT

A backlight module of the present invention includes a light source unit and a light guide plate. The light guide plate has a light incident surface, and the light emitting unit is disposed corresponding to the light incident surface to provide a light incident on the light guide plate. The light marches in the light guide plate and provides a uniform lighting effect. A plurality of microstructures is disposed on the light incident surface, and each of the microstructure has a microstructure depth. The light guide plate has a plate thickness. The ratio of the microstructure depth to the plate thickness is substantially between 0.003 and 0.0625.

This application claims the priority based on a Taiwanese Patent Application No. 097124981, filed on Jul. 2, 2008, the disclosure of which is incorporated herein by reference in its entirety.

### BACKGROUND OF THE INVENTION

1. Field of the Invention

The present invention generally relates to a light guide plate and a backlight module using the same. Particularly, the present invention relates to a light guide plate for display devices and a backlight module using the same.

2. Description of the Prior Art

Display devices have been widely used in a variety of electronic products such as televisions, laptops, mobile phones, and personal digital assistants (PDAs). The liquid crystal display (LCD) devices are particularly applied to various consumer products. Since the size of LCD devices becomes larger and larger and the functionality as well as the quality thereof becomes better and better, the business market grows more and more prosperous. A backlight module is one of the major components of display devices. Because the liquid crystal materials in LCD devices cannot emit light, the backlight module is required to provide light for achieving the displaying effect. Currently, as the market of LCD devices enormously grows, the backlight modules for LCD devices have become diverse in order to satisfy the appearance and functional requirements of LCD devices.

A backlight module generally includes a light guide plate, a light emitting unit, a reflector, and at least one optical film. In order to satisfy several purposes including low power, high luminosity, light uniformity, and adjustable viewing angle, the optical components in the backlight module, such as the light guide plate and other optical films, can have different optical design for improving the usability of light. The major function of the light guide plate is to guide the transmission direction of the light to achieve a uniform light distribution. Currently, if the surface of the light guide plate is smoother, the light of lager incident angle will scatter resulting in the decrease in the light coupling efficiency and the adverse impact on the viewing angle and the light uniformity. In the case that the incident surface of the light guide plate is mirror-like, according to Fresnel's law, the specular reflection will increase rapidly with the incident angle larger than sixty degree and result in the energy loss and light coupling efficiency decreasing. In addition, the narrow spread angle of in-coupled light in the light guide plate adversely affects the uniformity. One method to solve this problem is to adopt a light source having a broader light emitting angle. For example, with reference to FIG. 1A, the light source 100′ includes a light emitting diode (LED) 101′ with a periscopic package 103′ instead of the light source 100 having the LED 101 a traditional package 103. In comparison with the traditional prism package, the half sphere prism package 103′ allows the LED lamp 101′ to have larger effective light emitting angle.

Moreover, the light emitting unit of the backlight module usually includes LEDs, which serves as a point light source. While the light emitted from the point light source is incident on the mirror-like surface of the light guide plate, hotspots are generally formed on the mirror-like incident surface of the light guide plate resulting in the non-uniform in light distribution and undesired light spots. FIG. 1B shows a side view of the light source 100 (or 100′) and a traditional light guide plate 130. As shown in FIG. 1B, the microstructures on the incident surface of the light guide plate 130 may improve the hotspot phenomenon; however, as the arrow X of FIG. 1B indicates, when light emitted from the light source 100 is incident on the microstructures of the light guide plate 130, some light leaks from the interstices of the microstructures so that the light coupling efficiency is decreased.

### SUMMARY OF THE INVENTION

It is an object of the present invention to provide a backlight module having a better light coupling (or through put) efficiency and an improved light uniformity.

It is another object of the present invention to provide a light guide plate capable of eliminating hotspots and creating a uniform light distribution.

The present invention provides a backlight module having a light emitting unit and a light guide plate. The light guide plate includes a light incident surface. The light emitting unit is disposed corresponding to the light incident surface of the light guide plate for emitting light entering the light guide plate through the light incident surface. The light travels through the light guide plate so as to provide a uniform light distribution. A plurality of microstructures is disposed on the light incident surface. Each of the microstructures has a microstructure depth along a normal direction of the light incident surface. The light guide plate includes a plate thickness in a direction perpendicular to the normal direction of the light incident surface. The ratio of the microstructure depth to the plate thickness is substantially between 0.003 and 0.0625.

### BRIEF DESCRIPTION OF THE DRAWINGS

FIG. 1A shows a schematic view of a traditional light source;

FIG. 1B shows a side view of a light source and a traditional light guide plate having a microstructure;

FIG. 2 shows an explosive view of a backlight module in accordance with one embodiment of the present invention;

FIG. 3 shows a cross-sectional view of the light guide plate and the light emitting unit along the cutting line A-A′ of FIG. 2;

FIG. 4 shows the relationship between the ratio (D/L) and the light coupling (or through put) efficiency in accordance with one embodiment of the present invention.

FIG. 5A shows a partial enlarged schematic view of the microstructures of the light guide plate of FIG. 2;

FIG. 5B shows a partial enlarged schematic view of microstructures of a light guide plate in accordance with another embodiment of the present invention;

FIG. 6A is a partial schematic view showing the light from the light emitting unit incident on the microstructures of the present invention; and

FIG. 6B shows a side view of the light guide plate and the light source of FIG. 6A.

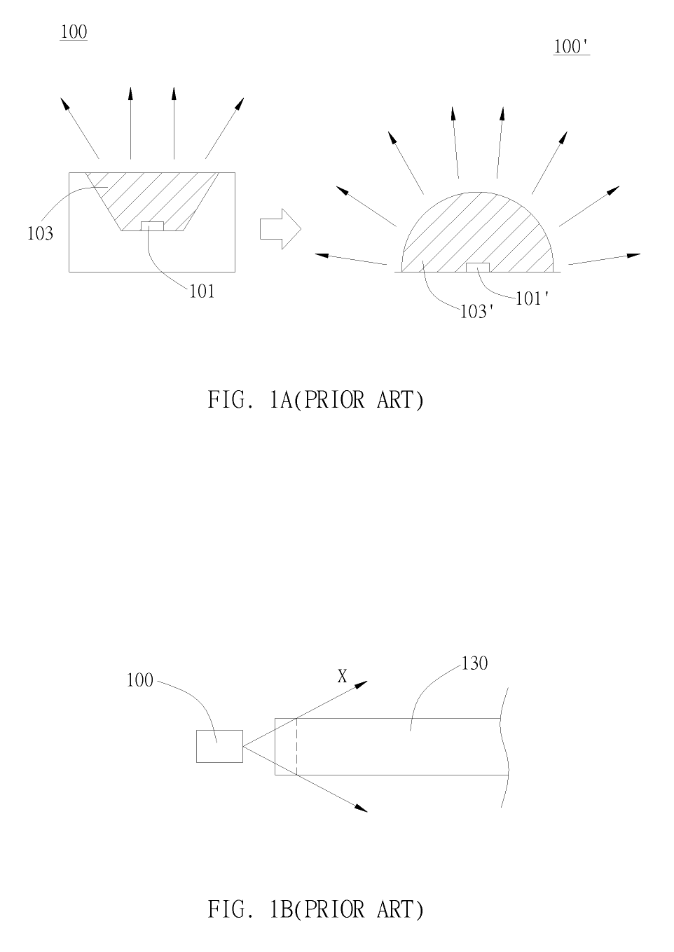

### DETAILED DESCRIPTION OF THE PREFERRED EMBODIMENT

The present invention provides a light guide plate and a backlight module using the light guide plate. In an embodiment, the backlight module is used for liquid crystal display (LCD) panel. However, in other embodiments, the backlight module can be used for QWERTY keyboards, keypads, panels, and other devices requiring flat light source. Furthermore, the present invention includes a display device using the light guide plate, including home LCD televisions, liquid crystal monitors of personal computers and laptops, and liquid crystal displays of the mobile phones and digital cameras.

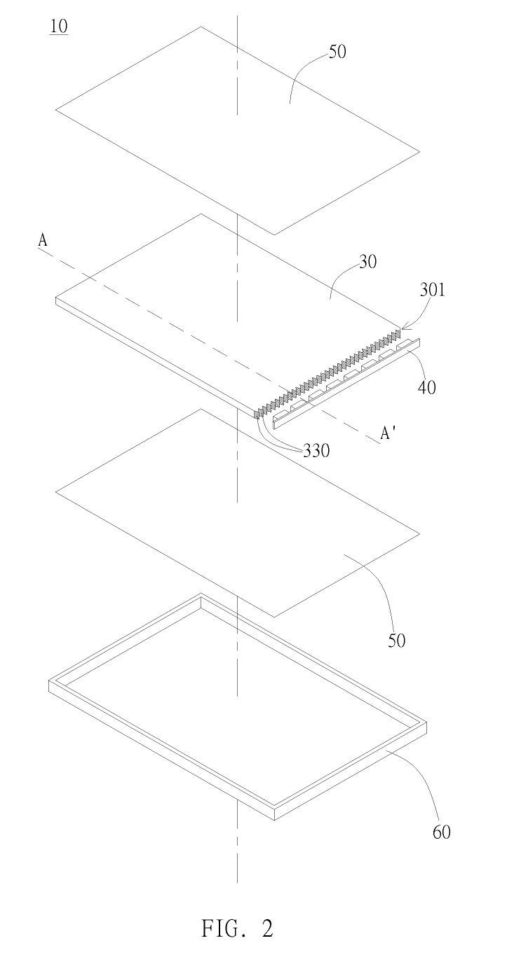

FIG. 2 shows an explosive view of a backlight module 10 in accordance with one embodiment of the present invention. The backlight module 10 includes a light guide plate 30, a light emitting unit 40, an optical film 50, and a frame 60. The light guide plate 30, the light emitting unit 40, and the optical film 50 are disposed in the frame 60. The optical film 50 overlaps the light guide plate 30. The frame 60 can support or position the light guide plate 30, the light emitting unit 40, and the optical film 50. The number and type of the optical film 50 can be modified according to different designs. However, in other embodiments, the optical film 50 may not be included in the back light module. The backlight module 10 of the present invention is an edge type backlight module, which has a linear light source disposed on a side to project the light from the light source throughout an entire display surface. That is, the light emitting unit 40 is disposed close to a side of the light guide plate 30 but not overlaps the light guide plate 30. In the embodiment, the light emitting unit 40 includes point light sources, such as light emitting diodes. However, in other embodiments, the light emitting unit can be a tube type linear light source, such as a tube lamp, or any suitable light emitting device arranged in a line.

With reference to FIG. 2, in the embodiment, one side of the light guide plate 30 adjacent to the light emitting unit 40 is a light incident surface 301 for receiving light from the light emitting unit 40. The light guide plate 30 further includes a plurality of microstructures 330 disposed on the light incident surface 301. As shown in FIG. 2, the microstructure 330 of the embodiment has a concave-convex structure. Along the normal direction of the light incident surface 301 (i.e. a direction perpendicular to the light incident surface), the microstructure 330 is recessed in the light incident surface 301 to form a concave portion and protrudes from the light incident surface 301 to form a convex portion so that a plurality of concave grooves are formed.

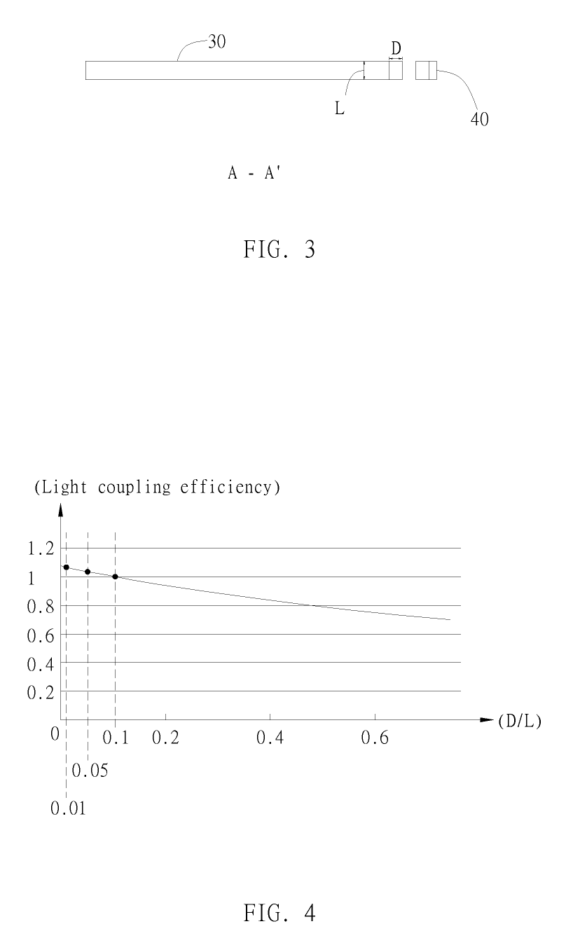

FIG. 3 shows a cross-sectional view of the light guide plate 30 and the light emitting unit 40 along the cutting line A-A′ of FIG. 2. As shown in FIG. 3, the recessed depth of the microstructure 330 along the normal direction of the light incident surface 301 is defined as a microstructure depth D. The light guide plate 30 has a plate thickness L in a direction perpendicular to the normal direction of the light incident surface 301. In the embodiment, a ratio of the microstructure depth D to the plate thickness L is substantially between 0.003 and 0.0625. For example, in the case that the plate thickness L of the light guide plate for a large size display panel is about 800 μm, the microstructure depth D will be in a range between 2.4 μm and 50 μm. Preferably, the ratio of the microstructure depth D to the plate thickness L is between 0.01 and 0.05. In other words, In the case that the plate thickness L of the light guide plate is 800 μm, the microstructure depth D preferably ranges between 8 μm and 40 μm.

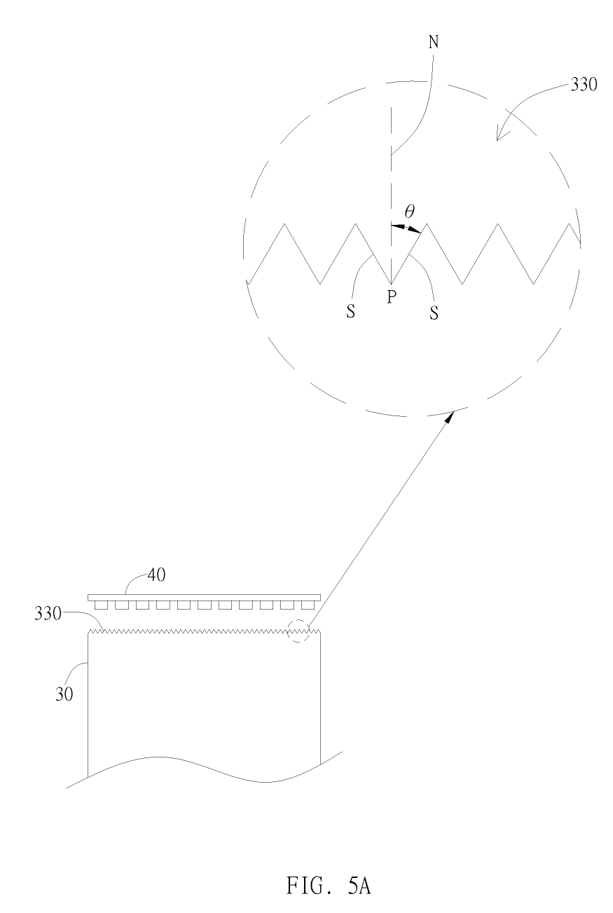

The ratio (D/L) of the microstructure depth D to the plate thickness L defined within the range of the embodiments can achieve a better light coupling (or through put) efficiency. FIG. 4 shows the relationship between the ratio (D/L) of the microstructure depth D to the plate thickness L and the light coupling (or through put) efficiency in accordance with one embodiment of the present invention. As shown in FIG. 4, the light coupling (or through put) efficiency will be improved by at least 3% when the ratio (D/L) is between 0.01 and 0.05 in comparison with the ratio (D/L) greater than 0.1. Moreover, when the (D/L) ratio of the microstructure is between 0.003 and 0.0625, the light coupling (or through put) efficiency will be improved in comparison with the conventional microstructure. In this plot, we normalize light coupling efficiency of a mirror-like surface to 1.

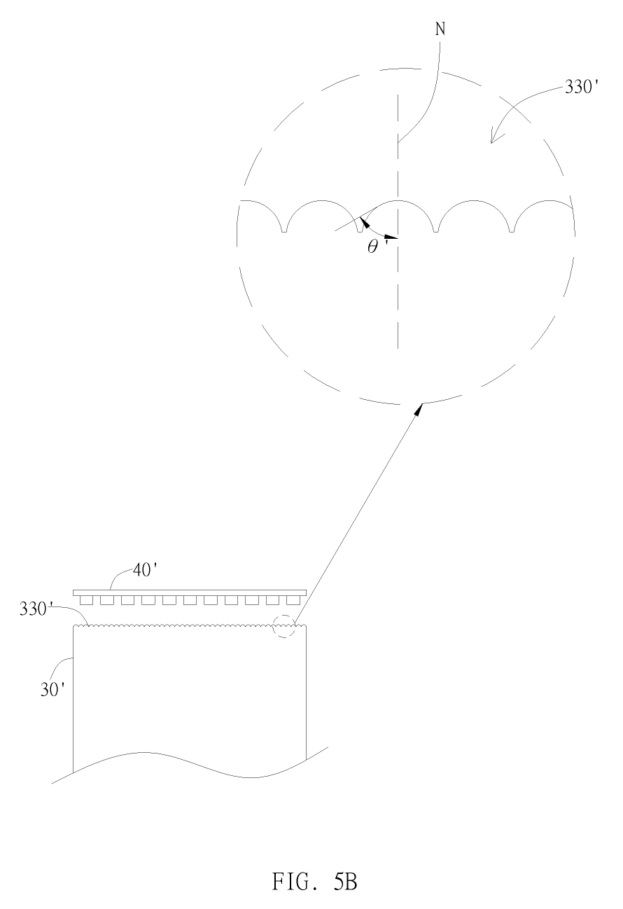

FIG. 5A shows a partial enlarged schematic view of the microstructures 330 of the light guide plate 30 of FIG. 2. In the embodiment, the microstructure 330 on the light guide plate 30 has a V shaped cross-section on a cross-sectional plane parallel to the normal direction of the light incident surface. As shown in the drawing, the V shaped concave portion has a plurality of vertexes P and inclined surfaces S joined therebetween. An included angle θ between the extending direction of the inclined surface S and the normal direction N of the light incident surface 301 is preferably between 30° and 60°. However, in other embodiments, the microstructures can have different configurations. With reference to FIG. 5B, the light guide plate 30′ has a microstructure 330′ with an arc cross-section on a cross-section plane parallel to the normal direction of the light incident surface. In other words, the microstructure 330′ has a plurality of arcs. An included angle θ′ between a tangent direction extending from a zenith of the arc and a normal direction N of the light incident surface is preferably between 30° and 60°. Furthermore, in other embodiments, the light incident surface can include at least one V shaped cross-section (microstructure) and at least one arc cross-section (microstructure). Nevertheless, the microstructure of the light guide plate is not limited to the embodiment and can be modified according to different designs. The principle of the light guide plate and the microstructures of the present invention designed to have the plate thickness L corresponding to the microstructure depth D achieving a better light coupling (or through put) efficiency on the light incident surface 301 of the light guide plate 30 will be described below.

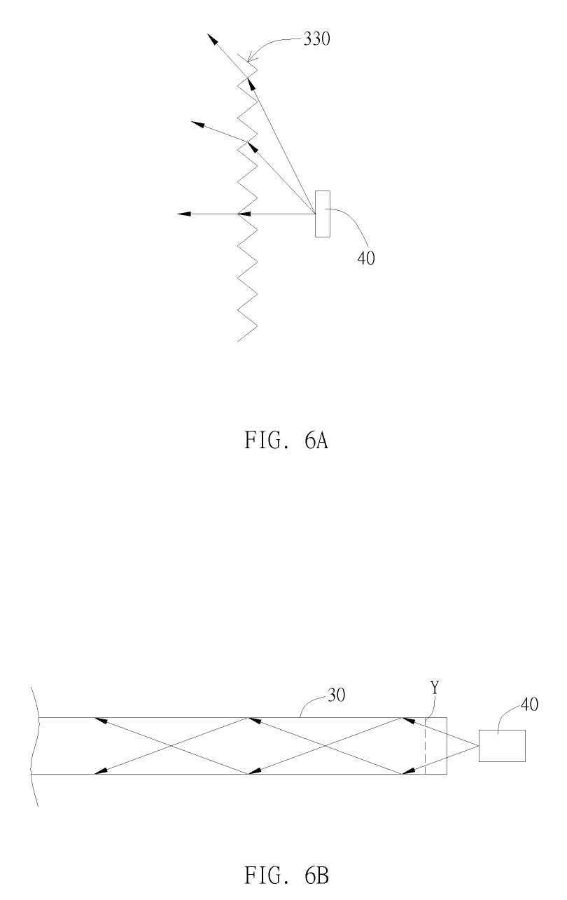

Based on the law of reflection, the larger incident angle the incident light has, the larger fraction angle the reflective light will have. In other words, the transmittance (the ability of an object to be passed by light) will decrease with the incident angle. FIG. 6A is a partial schematic view showing the light from the light emitting unit 40 incident on the V shape microstructures 330 (as the arrows indicate). As shown in FIG. 6A, the light is incident on the inclined surface of the light incident surface 301 of the microstructure 330. Since the included angle between an extending direction of the inclined surface of the microstructure 330 and the normal direction of the light incident surface is between 30° and 60°, the incident light mostly penetrates through the light incident surface 301 into the light guide plate 30. The light guide plate 30 of the present invention has a higher transmittance than the prior art having a mirror-like surface as the light incident surface. FIG. 6B shows a side view of the light guide plate 30 and light emitting unit 40 in accordance with one embodiment of the present invention. The light guide plate 30 of the embodiment has a specific ratio of the microstructure depth D to the plate thickness L so that the light Y emitted from the light source (e.g. the light emitting unit 40) has a smaller chance to leak to outside through the interstices between the microstructures. Therefore, the light Y will be substantially coupled into the light guide plate 30.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A backlight module, comprising:
a light emitting unit; and
a light guide plate having a light incident surface, wherein the light emitting unit adjacently facing the light incident surface, a plurality of microstructures are disposed on the light incident surface, each of the microstructures has a microstructure depth along a normal direction of the light incident surface, the light guide plate has a plate thickness in a direction perpendicular to the normal direction of the light incident surface, and a ratio of the microstructure depth to the plate thickness is substantially between 0.003 and 0.0625.

2. The backlight module of claim 1, wherein the microstructures have a plurality of vertexes and inclined surfaces joined therebetween, and an included angle between an extending direction of the inclined surface and a normal direction of the light incident surface is between 30° and 60°.

3. The backlight module of claim 2, wherein each of the microstructures has a V shaped cross-section on a cross-section plane parallel to the normal direction of the light incident surface.

4. The backlight module of claim 1, wherein the microstructures have a plurality of arcs, and an included angle between a direction extending from a zenith of the arc and the normal direction of the light incident surface is between 30° and 60°.

5. The backlight module of claim 4, wherein each of the microstructures has an arc cross-section on a cross-section plane parallel to the normal direction of the light incident surface.

6. The backlight module of claim 1, wherein the microstructures include at least one V shaped cross-section and at least one arc cross-section.

7. The backlight module of claim 1, wherein a ratio of the microstructure depth to the plate thickness is substantially between 0.01 and 0.05.

8. The backlight module of claim 1, wherein the plate thickness is about 800 μm, and the microstructure depth is about 2.4 μm to 50 μm.

9. The backlight module of claim 1, wherein the light emitting unit includes a point light source.

10. The backlight module of claim 9, wherein the light emitting unit includes a light emitting diode.

11. The backlight module of claim 1, wherein the light emitting unit includes a linear light source.

12. The backlight module of claim 11, wherein the light emitting unit includes a tube lamp.

13. A light guide plate for a backlight module, wherein one side of the light guide plate has a light incident surface, a plurality of microstructures are disposed on the light incident surface, each of the microstructures has a microstructure depth along a normal direction of the light incident surface, the light guide plate has a plate thickness in a direction perpendicular to the normal direction of the light incident surface, and a ratio of the microstructure depth to the plate thickness is substantially between 0.003 and 0.0625.

14. The light guide plate of claim 13, wherein the microstructures have a plurality of vertexes and inclined surfaces joined therebetween, and an included angle between an extending direction of the inclined surface and the normal direction of the light incident surface is between 30° and 60°.

15. The light guide plate of claim 14, wherein each of the microstructures has a V shaped cross-section on a cross-section plane parallel to the normal direction of the light incident surface.

16. The light guide plate of claim 13, wherein each of the microstructures has an arc cross-section on a cross-section plane parallel to the normal direction of the light incident surface.

17. The light guide plate of claim 13, wherein the microstructures include at least one V shaped cross-section and at least one arc cross-section.

18. The light guide plate of claim 13, wherein a ratio of the microstructure depth to the plate thickness is substantially between 0.01 and 0.05.
